(19) United States
(12) Patent Application Publication
(10) Pub. No.: US 2013/0303834 A1
(43) Pub. Date: Nov. 14, 2013

(54) HUMIDITY CONTROL SYSTEM FOR WARMING THERAPY DEVICE INCLUDING DUCT COVER WITH AIR FLOW TRENCH

(71) Applicant: Jacob Gershteyn, Newtown, PA (US)

(72) Inventor: Jacob Gershteyn, Newtown, PA (US)

(73) Assignee: Draeger Medical Systems, Inc., Telford, PA (US)

(21) Appl. No.: 13/883,128

(22) PCT Filed: Nov. 12, 2010
(86) PCT No.: PCT/US10/56493

§ 371 Date: Jul. 2, 2013

(51) Int. Cl. A61G 11/00

(52) U.S. Cl. CPC A61G 11/00
USPC 600/22

(57) ABSTRACT

An apparatus and method for performing warming therapy is described. In one exemplary embodiment, the apparatus includes a base for supporting a medical patient and a duct cover removably coupled to the base. The duct cover may include first and second portions which cooperate with one another to form an air flow trench between a humidifier module and a fan unit. The duct cover operates to direct humidified air from the humidifier module directly to the fan unit, so that excess moisture around the apparatus is minimized.

### FIELD OF THE INVENTION

This present invention relates generally to a method and apparatus for performing warming therapy on medical patients. More particularly, the present invention relates to a method and apparatus for humidifying air supplied to a medical patient disposed within an enclosure.

### BACKGROUND OF THE INVENTION

It is known to control both the temperature and relative humidity of the air adjacent a medical patient (e.g., infant) in a warming therapy device. For example, many warming therapy devices (e.g., incubators, warmers, etc.) include systems which are designed to control the temperature and humidity of the environment surrounding an infant patient disposed inside a hood of the warming therapy device. To control the temperature and humidity within the warming therapy device, the existing temperature and humidity are sensed and then adjusted. The temperature within the warming therapy device may be adjusted using a heating element located within the air circulation system of the warming therapy device and responsive to a temperature sensor. The humidity within a warming therapy device may be adjusted using a humidification device that is adapted to inject humidity into the air circulation system of the warming therapy device.

Humidification systems typically comprise at least a water reservoir, a boiling chamber, and a heating element. The heating element typically acts to heat the water within the boiling chamber, and thus create humidity by adding water vapor to heated air. Humidification systems sometimes create excess moisture (e.g., leaking) outside the warming therapy device due to inadequate sealing between the various elements of the humidification system. For example, condensed water can leak onto the floor below the warming therapy device. In this respect, it is desirable to implement a warming therapy device which does not generate excess moisture outside of the warming therapy device during operation.

The temperature, humidity and oxygen concentration of the air within a warming therapy device are typically controlled by a forced air circulation system, where the impeller of a fan unit re-circulates the air. In most cases, the total flow of both fresh and re-circulated air is directed across an air heater unit. In such a configuration, the air pressure around the air heater is always greater than the atmospheric pressure, and the air pressure is always less than the atmospheric pressure at the entrance to the fan unit. For example, some conventional humidification systems include a fan unit, a heater unit, and a humidifier unit, such that the humidifier unit supplies steam from a boiling chamber directly to the heater unit, where the air pressure is greater than the atmospheric pressure. This type of design requires good sealing between the boiling chamber of the humidifier unit and the heater unit because of the fact that back pressure can cause the leakage of humid air outside the warming therapy device (in which the humidification system is contained). However, if the humidification system supplies the humidified air before the entrance to the fan unit, the air flow is drawn from the boiling chamber directly to the impeller of the fan unit. There will be no back pressure created in such a design, and thus no leakage of humid air. Thus, it is desirable to have a humidification systems where humidified air is effectively transmitted to the impeller of a fan unit for distribution.

Excess moisture concentrated outside of a warming therapy device can create several problems. For one, the excess moisture can accumulate and cause liquid to develop on the floor beneath the warming therapy device, which can result in accidents by health care personnel. The excess moisture can also provide a forum to grow bacteria in and around the warming therapy device. Because one of the objectives of a warming therapy device is to create a sterile and hygienically sound environment for the patient, which is also free from potentially hazardous conditions, a humidification system which does not generate excess moisture outside of a warming therapy device is highly desirable.

Accordingly, there is presently a need for a warming therapy device that contains a humidification system which does not generate excess moisture outside of the warming therapy device.

### SUMMARY OF THE INVENTION

An exemplary embodiment of the present invention comprises an apparatus including a base for supporting a medical patient, a fan unit disposed within the base and a duct cover removably coupled to the base, the duct cover including first and second portions, wherein the second portion is shaped so as to fit within the first portion.

An exemplary embodiment of the present invention also comprises a duct cover including a first portion and a second portion adapted to fit within the first portion, wherein the first portion includes first and second openings formed therein and a trench connecting the first and second openings.

An exemplary embodiment of the present invention also comprises an apparatus including a base for supporting a medical patient, a pedestal supporting the base, a hood surrounding a portion of the base, a fan unit disposed within the base and a duct cover removably coupled to the base, the duct cover including first and second portions.

### BRIEF DESCRIPTION OF THE DRAWINGS

FIG. 1 is a perspective view of a warming therapy device according to a first exemplary embodiment of the present invention, including a base and a hood enclosing the base.

FIG. 2 is an exploded perspective view of the base and hood of the warming therapy device shown in FIG. 1 with a sidewall of the hood removed for clarity.

FIG. 3 is a bottom perspective view of a first portion of a duct cover according to a first exemplary embodiment of the present invention.

FIG. 4 is a top perspective view of the first portion of the duct cover shown in FIG. 3.

FIG. 5 is a top view of the first portion of the duct cover shown in FIG. 3.

FIG. 6 is a side view of the first portion of the duct cover shown in FIG. 3.

FIG. 7 is a detail cross-section view of the first portion of the duct cover shown in FIG. 3, taken along lines A-A in FIG. 6.

FIG. 8 is a detail cross-section view of the first portion of the duct cover shown in FIG. 3, taken along lines B-B in FIG. 5.

FIG. 9 is a detail cross-section view of the first portion of the duct cover shown in FIG. 3, taken along lines C-C in FIG. 5.

FIG. 10 is a detail cross-section view of the first portion of the duct cover shown in FIG. 3, taken along lines D-D in FIG. 5.

FIG. 11 is a bottom perspective view of a second portion of a duct cover according to a first exemplary embodiment of the present invention.

FIG. 12 is a top perspective view of the second portion of the duct cover shown in FIG. 11.

FIG. 13 is a top view of the second portion of the duct cover shown in FIG. 11.

FIG. 14 is a side view of the second portion of the duct cover shown in FIG. 11.

FIG. 15 is a detail cross-section view of the second portion of the duct cover shown in FIG. 11, taken along lines A-A in FIG. 14.

FIG. 16 is a detail cross-section view of the second portion of the duct cover shown in FIG. 11, taken along lines B-B in FIG. 13.

FIG. 17 is a detail cross-section view of the second portion of the duct cover shown in FIG. 11, taken along lines C-C in FIG. 13.

FIG. 18 is a detail cross-section view of the second portion of the duct cover shown in FIG. 11, taken along lines D-D in FIG. 13.

FIG. 19 is a detail cross-section view of the second portion of the duct cover shown in FIG. 11, taken along lines E-E in FIG. 13.

FIG. 20(a) is a top perspective view of a duct cover according to a first exemplary embodiment of the present invention.

FIG. 20(b) is a top perspective view of a duct cover according to a first exemplary embodiment of the present invention, with the second portion removed.

FIG. 21 is a side cross-section view showing the intersection of the duct cover according to a first exemplary embodiment of the present invention and a boiling chamber of a humidifier module.

### DETAILED DESCRIPTION

The present invention relates to a warming therapy device (e.g., incubator, warmer, etc.) including a humidification system which is ducted to prevent the accumulation of excess moisture outside of the warming therapy device. In particular, the warming therapy device includes a duct cover for directing humidified air into an incubation chamber, so as to avoid the formation of excess moisture in the area around the warming therapy device.

By way of example, the humidification system according to the exemplary embodiments of the present invention may be used in connection with an incubator and humidity sensor such as are disclosed and discussed in U.S. Pat. No. 6,711,937 (assigned to the same assignee as the present application), which is hereby incorporated by reference in its entirety, as if fully set forth herein. For example, U.S. Pat. No. 6,711,937 describes an incubator 26 having a base 11 into which a humidifier module 23 may be inserted. The incubator 26 also includes a sensor module 10 for sensing conditions such as temperature and humidity within the incubator, and providing control signals for regulating the same.

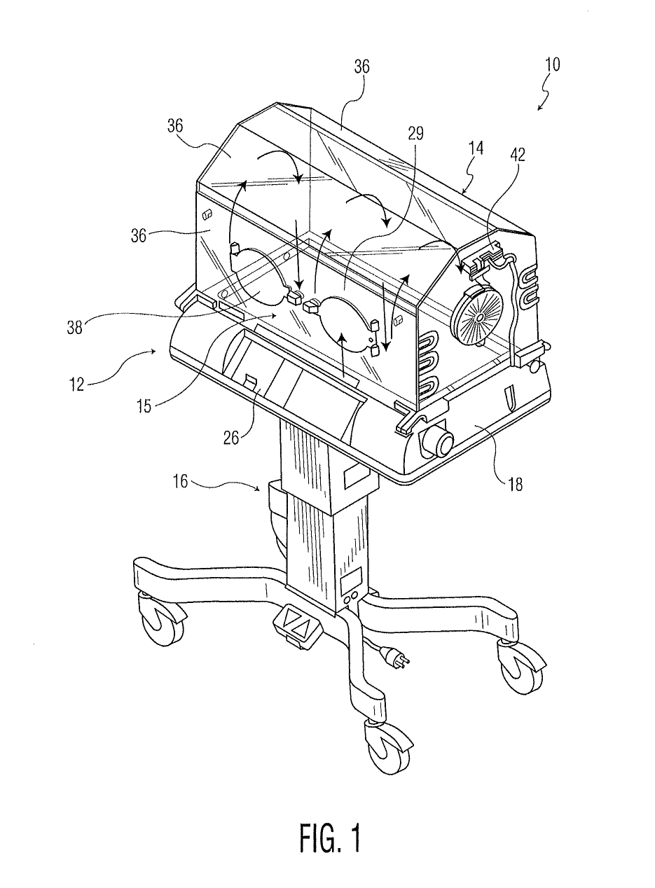

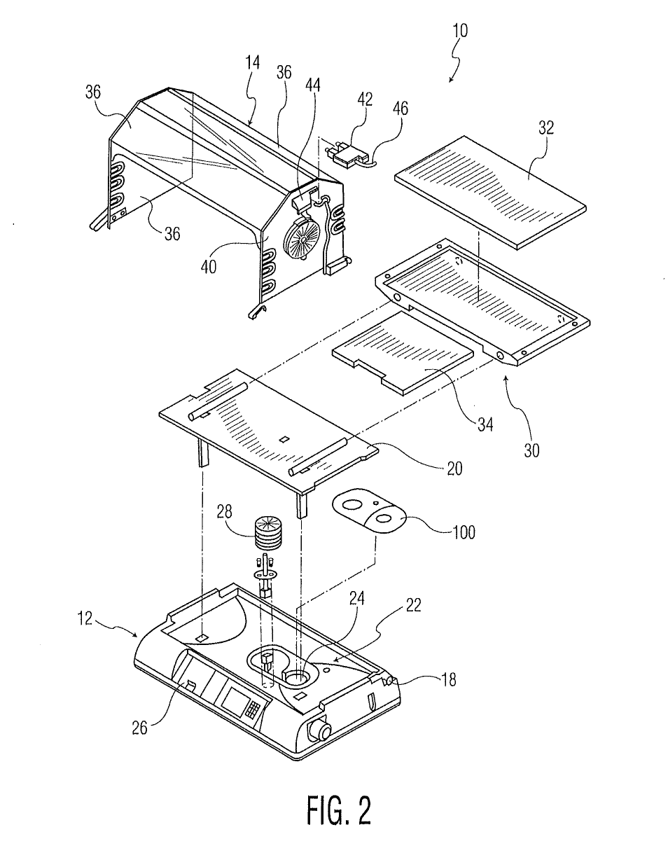

Closed care warming therapy devices (e.g., incubators) provide physical separation between the environment where the infant patient is disposed and the surrounding ambient air. This separation is typically provided by a hood or similar member which encloses the infant patient therein. This encapsulation of the infant patient facilitates creation of conditions favorable for the infant patient's development, Often times, the conditions inside the hood can be significantly different from those present in the ambient environment. Conditions inside the hood may be determined by varying the temperature level, humidity and/or oxygen concentration within the closed care environment, all of which can be controlled automatically using sensors integrated in the warming therapy device. For example, the temperature within the closed care environment may be controlled by sensing the skin temperature of the infant patient and making appropriate adjustments. FIGS. 1 and 2, discussed below, show an exemplary close care warming therapy device.

Alternatively to closed care warming therapy devices, open care devices (e.g., heaters or warmers) supply heat (through, e.g., overhead infrared radiation) to the infant patient to promote development, and do not typically utilize a hood which separates the infant patient from the surrounding environment. The amount of heat supplied to the infant patient may be fixed, or controlled by one or more skin temperature sensors coupled to the patient, as noted above.

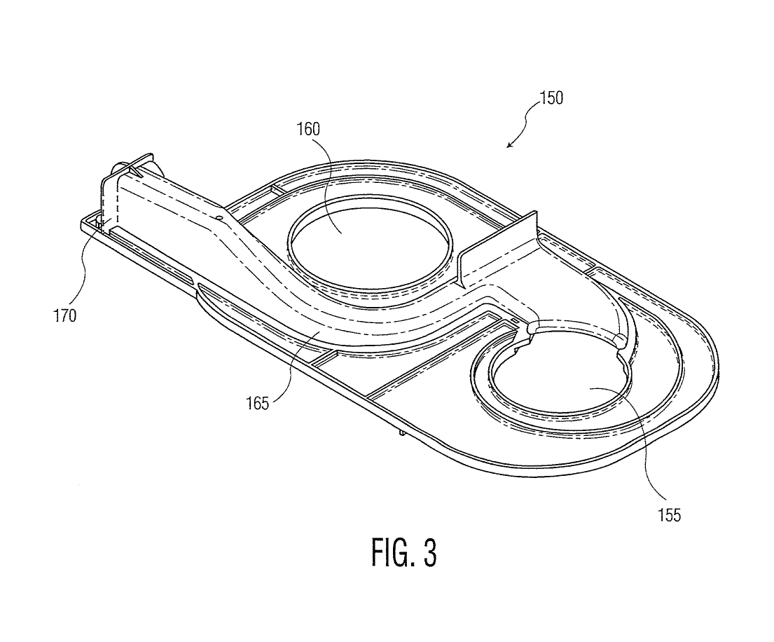

FIGS. 1 and 2 show a warming therapy device 10 according to a first exemplary embodiment of the present invention. The warming therapy device 10 includes a base 12 and a hood 14 which combine to form an enclosure, or incubation chamber 15, within which an infant can be received. The base 12 includes a pedestal 16, a main housing 18 and a deck 20 having an upwardly facing surface. The deck 20 and main housing 18 are configured to provide a plurality of apertures communicating with a below deck ducting 22. Base 12 includes an air conditioning system that includes a fan 24, air filter (not shown), humidifier module 26, oxygen source (not shown) and a heater 28 communicating with the below deck ducting 22. The fan 24 and heater 28 may be covered by a duct cover 100, as shown and described below with reference to FIGS. 3-20.

The illustrated warming therapy device 10 also includes an in-bed patient scale 30 configured to support a mattress 32 above an x-ray tray 34. The hood 14 includes a plurality of transparent walls 36 formed to include doors and portals 38 for access to an infant held within the enclosure. In the illustrated embodiment, an end wall 40 is formed with an aperture 44 for mounting a sensor module 42 therein.

The sensor module 42 may include a number of sensors, such as temperature, humidity, and oxygen level sensors. In particular, the humidity sensing portion of the sensor module 42 is adapted to detect the humidity level within the incubation chamber 15 and provide a signal to the humidifier module 26 through a data feed line 46.

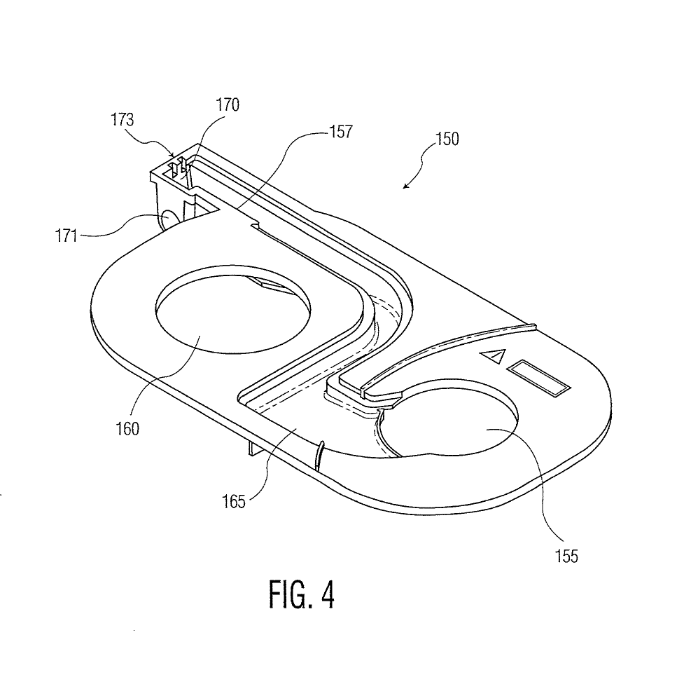

Referring now to FIGS. 3 and 4, a first portion 150 of a duct cover 100 according to a first exemplary embodiment of the present invention is shown. The first portion 150 includes a first opening 155 and a second opening 160 formed therein. The first opening 155 corresponds to the position of the fan 24 within the warming therapy device 10, and the second opening 160 correspond to the position of the heater 28 within the warming therapy device. The first portion 150 also includes a tab member 157 formed therein which cooperates with a cut-away member 183 formed on a second portion 180 of the duct cover 100, described below. The first portion 150 also includes a trench 165 formed therein which extends from the first opening 155 to a humidification port 170. The trench 165 operates to guide humidified air from the humidification port 170 directly to the fan 24, where it is circulated to the incubation chamber 15 of the warming therapy device. As will be understood by those of ordinary skill in the art, the humidification port 170 of the first portion 150 of a duct cover 100 is operatively coupled to the humidifier module 26 of the warming therapy device 10 (which generates the humidified air), as shown in FIG. 21. The first portion 150 also includes recesses 173 which cooperate with projections formed on a second portion 180 of the duct cover 100 (i.e., projections 185, 186 shown in FIGS. 11-13) to permit the first and second portions 150, 180 to snap-fit together.

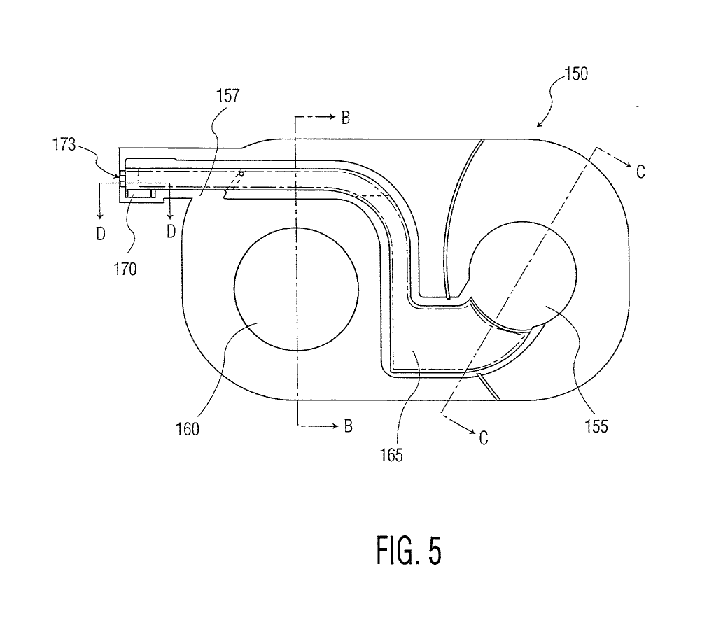

FIG. 5 shows a top view of the first portion 150 of the duct cover 100. As shown, the trench 165 creates a clear path for humidified air to travel from the humidification port 170 to the first opening 155, and thus to the fan 24.

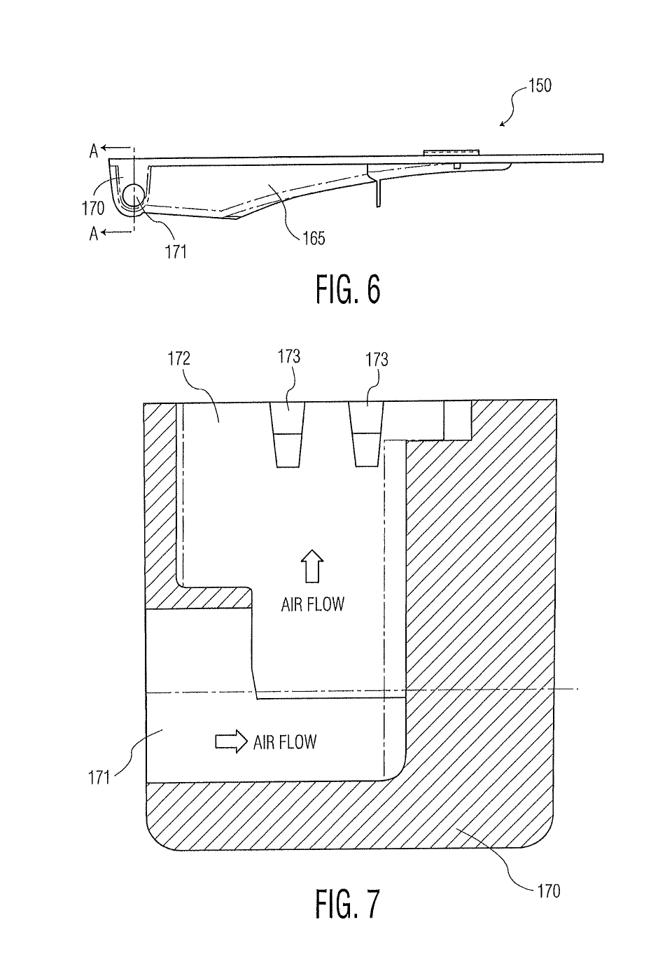

FIG. 6 shows a side view of the first portion 150 of the duct cover 100. As shown, the trench 165 has a depth which increases between the first opening 155 and the humidification port 170. FIG. 6 also shows that the humidification port 170 includes a first passage 171 for coupling to the humidifier module 26 of the warming therapy device 10.

FIG. 7 shows a detail cross-section view of the first portion 150 of the duct cover 100, taken along lines A-A in FIG. 6. As shown, the first passage 171 (for coupling to the humidifier module 26) is coupled to a second passage 172 which is integral with the trench 165. The first and second passages 171, 172 create an air flow channel from the humidifier module 26 to the trench 165. As noted above, humidified air flowing in the trench 165 exits at the first opening 155 of the first portion 150 of the duct cover 100, where it is circulated to the incubation chamber 15 by the fan 24.

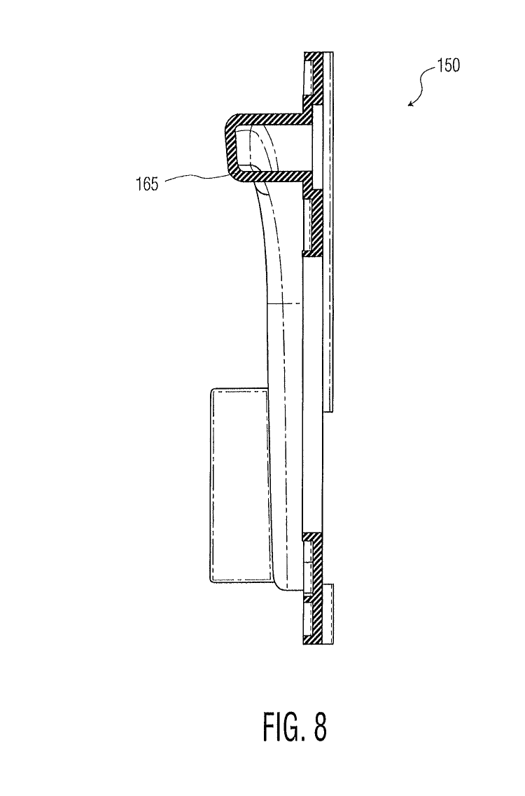

FIG. 8 is a detail cross-section view of the first portion 150 of the duct cover 100, taken along lines B-B in FIG. 5. FIG. 8 again shows that the depth of the trench 165 increases between the first opening 155 and the humidification port 170.

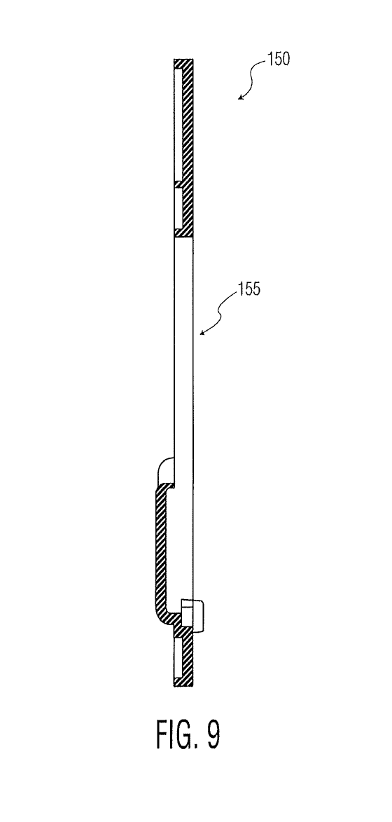

FIG. 9 is a detail cross-section view of the first portion 150 of the duct cover 100, taken along lines C-C in FIG. 5. As shown, the thickness of the first portion 150 is relatively uniform at the end in which the first opening 155 is disposed.

FIG. 10 is a detail cross-section view of the humidification port 170 of the first portion 150 of a duct cover 100, taken along lines D-D in FIG. 5. FIG. 10 shows the first passageway 171 which permits coupling to the humidifier module 26 of the warming therapy device 10, and which is coextensive with the trench 165 (not shown) via the second passageway 172 (not shown).

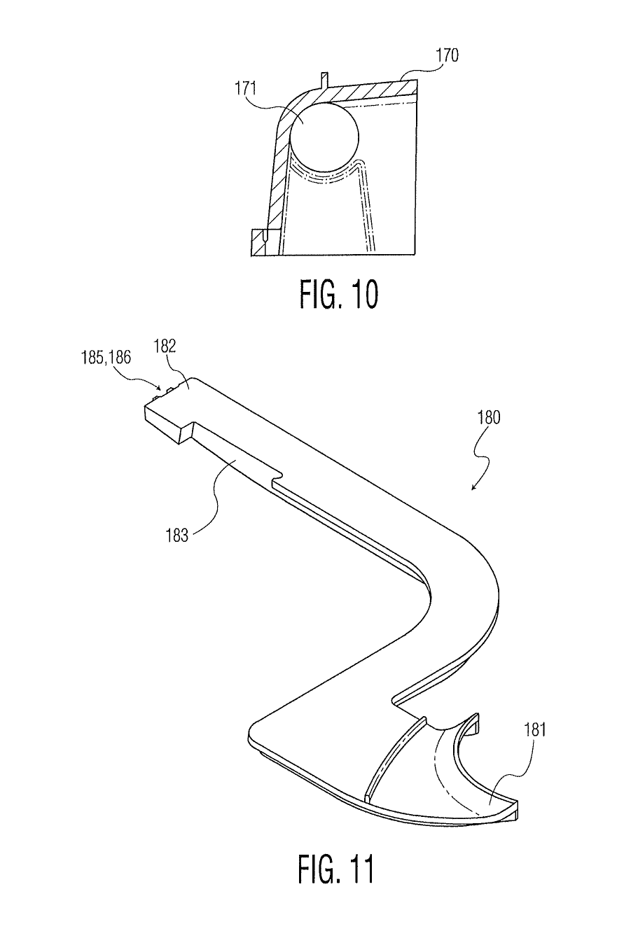

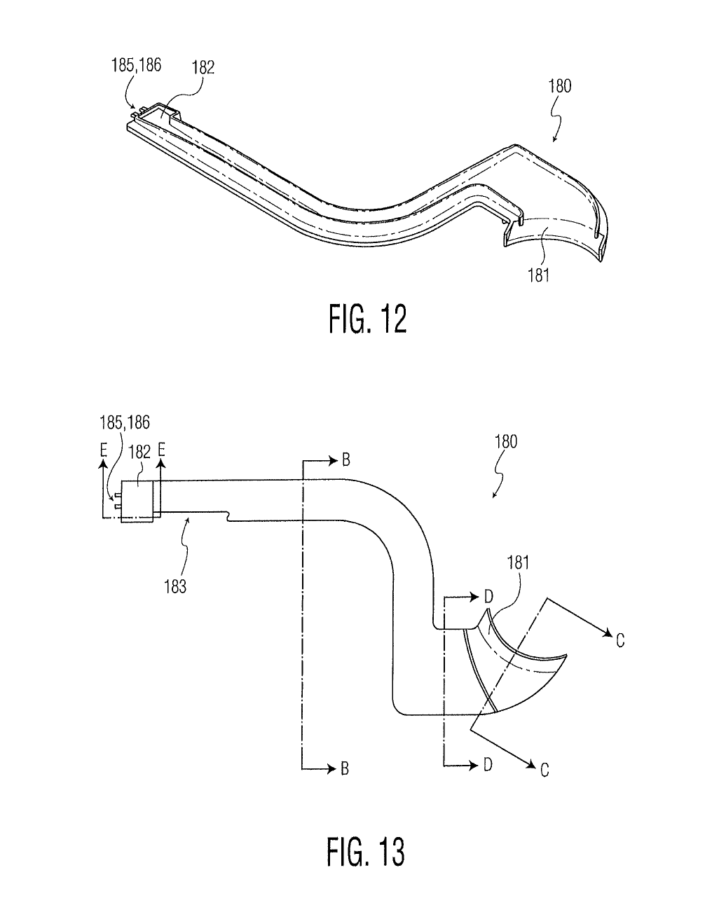

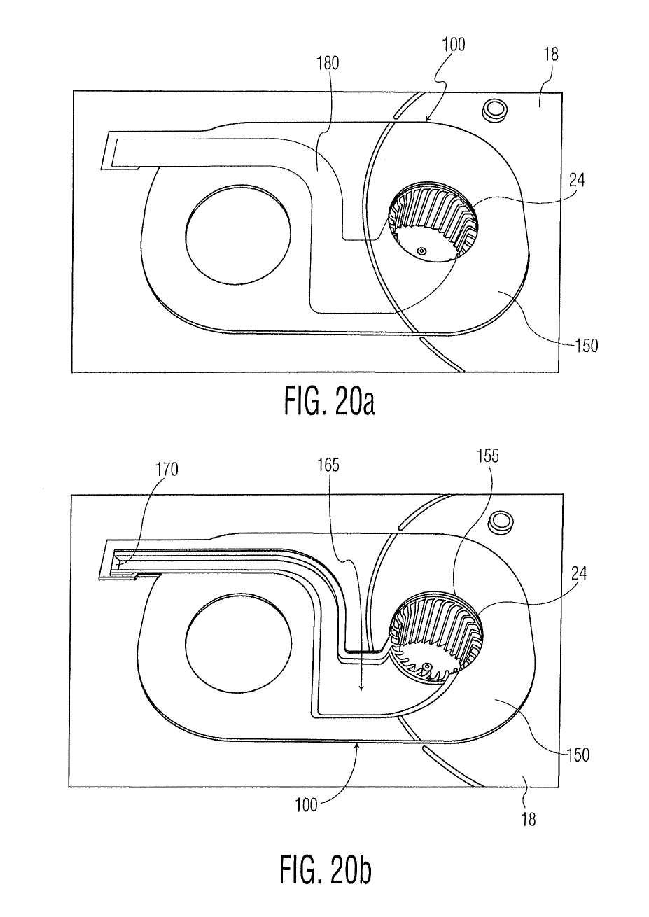

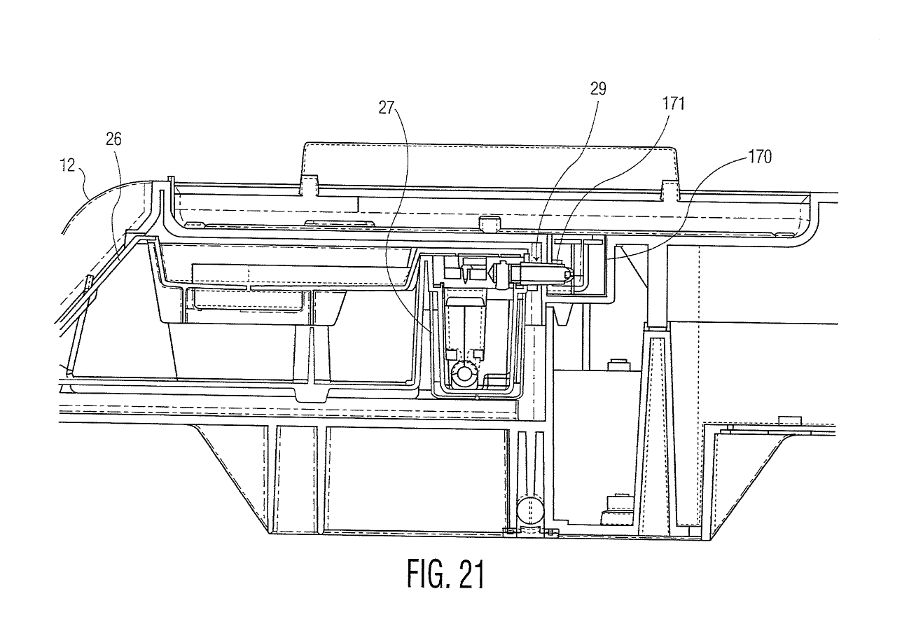

Referring now to FIGS. 11 and 12, a second portion 180 of a duct cover 100 according to a first exemplary embodiment of the present invention is shown. As those of ordinary skill in the art will recognize, the second portion 180 is adapted to fit within the trench 165 of the first portion 150 of the duct cover 100, as specifically shown in FIGS. 20(a) and 20(b). As will also be noted by those of ordinary skill in the art, both the first portion 150 and the second portion 180 have tortuous configurations, thereby forming a tortuous air flow path through the duct cover 100.

The second portion 180 includes a first end 181 which is semi-circular and cooperates with the first opening 155 of the first portion 150 of the duct cover 100. The second portion 180 also includes a second end 182 which is substantially rectangular and cooperates with the humidification port 170 of the first portion 150 of the duct cover 100. The second portion 180 also includes a cut-away member 183 which cooperates with the tab member 157 formed in the first portion 150 of the duct cover 100 to retain the second portion 180 within the first portion 150. As noted above in connection with FIGS. 3-4, the second portion 180 is held within the first portion 150 of the duct cover 100 by snap-fit engagement of first and second projections 185, 186 with recesses 173. Of course, those of ordinary skill in the art will realize that various snap-fit configurations for the first and second portions 150, 180 are within the scope of the present invention, and it is not limited to the particular snap-fit arrangement shown. Those of ordinary skill in the art will also realize that the second portion 180 may be held within the first portion 150 by means other than a snap-fit configuration, such as clips, screws, etc.

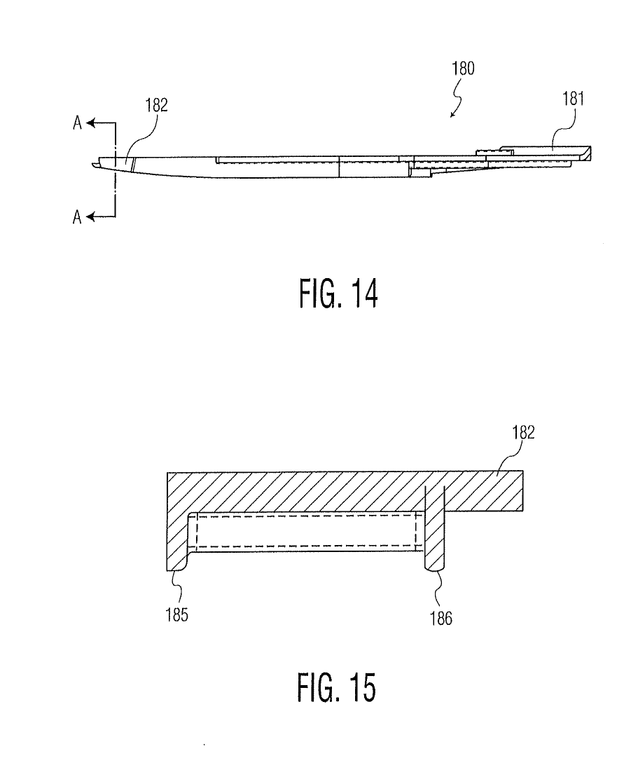

FIG. 13 shows a top view of the second portion 180 of the duct cover 100. FIG. 14 shows a side view of the second portion 180 of the duct cover 100. FIG. 15 shows a detail cross-section view of the second portion 180 of the duct cover 100, taken along lines A-A in FIG. 14.

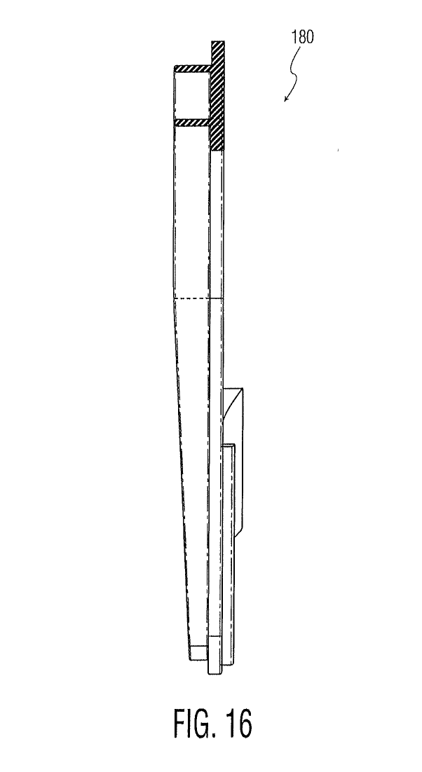

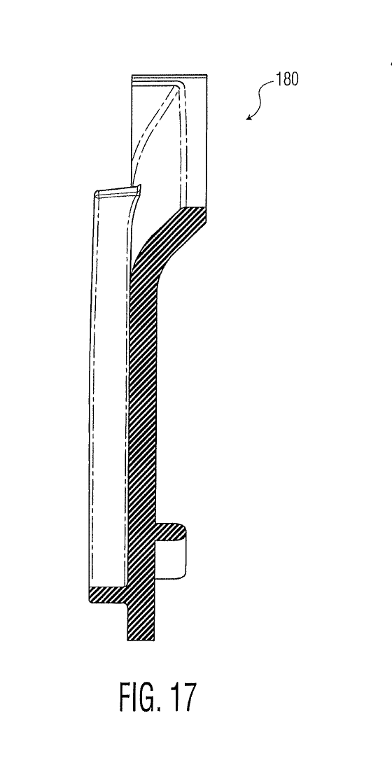

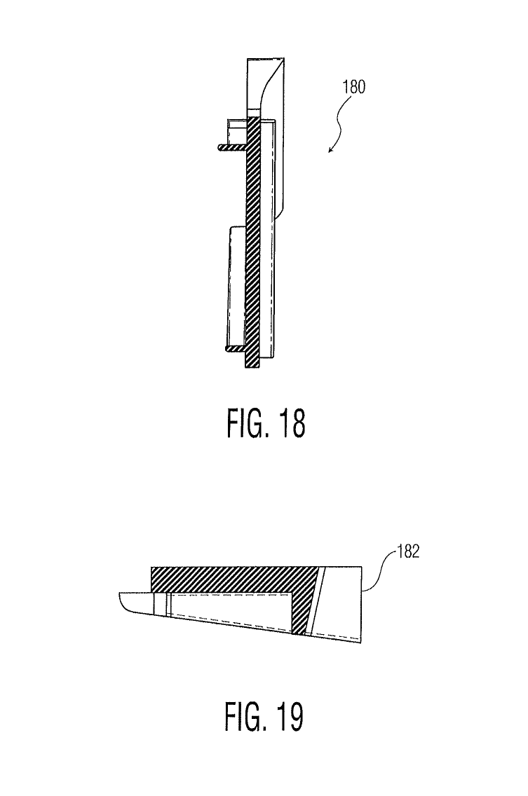

FIG. 16 is a detail cross-section view of the second portion 180 of the duct cover 100, taken along lines B-B in FIG. 13. FIG. 17 is a detail cross-section view of the second portion 180 of the duct cover 100, taken along lines C-C in FIG. 13. FIG. 18 is a detail cross-section view of the second portion 180 of the duct cover 100, taken along lines D-D in FIG. 13. Finally, FIG. 19 is a detail cross-section view of the second end 182 of the second portion 180 of the duct cover 100, taken along lines E-E in FIG. 13.

FIGS. 20(a) and 20(b) show the duct cover 100 disposed within the main housing 18 of the warming therapy device 10. FIG. 20(a) shows the duct cover 100 where both the first portion 150 and the second portion 180 are inserted therein. FIG. 20(b) shows the duct cover 100 with the second portion 180 removed to expose the trench 165 in the first portion 150. FIG. 20(b) shows how air flow is directed from the humidification port 170 to the first opening 155 using the trench 165. Once the humidified air reaches the opening 155, the fan 24 circulates the humidified air to the incubation chamber 15 (shown in FIGS. 1-2). When the first and second portions 150, 180 of the duct cover are disposed as shown in FIG. 20(a) an air flow trench is created between the humidifier module 26 and the fan 24, such that substantially no humidified air escapes the duct cover, and thus little or no excess moisture is generated in the area around the warming therapy device 10.

FIG. 21 is a side cross-section view of the base 12 of the warming therapy device 10 shown in FIGS. 1 and 2. The humidifier unit 26 is shown fully inserted in the base 12, such that a stem 29 of a boiling chamber 27 is inserted within the opening 171 in the humidification port 170 of the first portion 150 of the duct cover 100. Due to a negative pressure gradient created by the action of the fan unit 24, there is no requirement for a seal between the boiling chamber 27 and the duct cover 100. Thus, as shown in FIG. 21, there exists a space between the stem 29 of the boiling chamber 27 and the outer wall of the opening 171 in the humidification port 170.

Although the duct cover 100 according to the first exemplary embodiment is shown and described above with reference to an associated warming therapy device 10 of a specific configuration, those of ordinary skill in the art will realize that the duct cover 100 may be integrated into any suitable incubator, warmer, medical treatment device or other equivalent apparatus. Further, although the humidifier module 26 is described above with reference to air or oxygen comprising the heated and circulated gas, those of ordinary skill in the art will realize that any gas may be heated (or cooled) and circulated using the humidifier module 26 without departing from the scope of the present invention.

Although exemplary embodiment of the present invention has been described above for use in procedures involving infant patients, those of ordinary skill in the art will realize that the warming therapy device 10, humidifier module 26, and duct cover 100 according to the exemplary embodiment of the present invention may be used for other types of operations and procedures, including for children and adults, without departing from the scope of the present invention.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. An apparatus comprising:
a base for supporting a medical patient;
a fan unit disposed within the base; and,
a duct cover removably coupled to the base, the duct cover including first and second portions, wherein the second portion is shaped so as to fit within the first portion, and the first portion of the duct cover includes a humidification port for coupling to a humidifier module disposed within the base.

2. The apparatus of claim 1, wherein the first portion of the duct cover includes a first opening formed therein which corresponds to the position of the fan unit within the base.

3. The apparatus of claim 2, wherein the first portion of the duct cover includes a second opening formed therein which corresponds to the position of a heater unit disposed within the base.

4. The apparatus of claim 1, wherein the first portion of the duct cover includes a trench formed therein for directing air flow towards the fan unit.

5. (canceled)

6. The apparatus of claim 4, wherein the trench is deeper at a first end thereof which is distal from a first opening formed in the first portion of the duct cover.

7. The apparatus of claim 1, wherein the first portion of the duct cover includes first and second openings formed therein, said first and second openings being connected by a trench formed in the first portion of the duct cover.

8. The apparatus of claim 1, wherein the first and second portions of the duct cover form a tortuous air flow path.

9. The apparatus of claim 6, wherein the second opening is adjacent to the fan unit, and the trench operates to guide air flow from the first opening to the second opening.

10. The apparatus of claim 1, further comprising a humidifier unit which includes a stem portion which extends into an opening formed in the first portion of the duct cover.

11. A duct cover comprising:
a first portion; and,
a second portion adapted to fit within the first portion,
wherein the first portion includes first and second openings formed therein and a trench connecting the first and second openings.

12. The humidifier module of claim 10, wherein the first portion further comprises a humidification port disposed at an end of the first portion distal from the first opening.

13. The humidifier module of claim 10, wherein the trench is deeper at a first end thereof which is distal from the first opening.

14. An apparatus comprising:
a base for supporting a medical patient;
a pedestal supporting the base;
a hood surrounding a portion of the base;
a fan unit disposed within the base; and,
a duct cover removably coupled to the base, the duct cover including first and second portions.

15. The apparatus of claim 13, wherein the first portion of the duct cover includes a first opening formed therein which corresponds to the position of the fan unit within the base.

16. The apparatus of claim 13, wherein the first portion of the duct cover includes a second opening formed therein which corresponds to the position of a heater unit disposed within the base.

17. The apparatus of claim 13, wherein the first portion of the duct cover includes a trench formed therein for directing air flow towards the fan unit.

18. The apparatus of claim 13, further comprising a humidifier module disposed within the base.

19. The apparatus of claim 17, wherein a first end of the duct cover lies adjacent the humidifier module, and a second end of the duct cover lies adjacent the fan unit, such that humidified air produced by the humidifier module is conducted through the duct cover to the fan unit.

20. The apparatus of claim 13, further comprising a humidifier unit which includes a stem portion which extends into an opening formed in the first portion of the duct cover, such that a first space is created between the outer surface of the stem portion and the opening in the first portion of the duct cover.
